(19) United States
(12) Patent Application Publication
(10) Pub. No.: US 2013/0098643 A1
(43) Pub. Date: Apr. 25, 2013

(54) System and Method of Automatic Hose Bay Jam Prevention

(71) Applicants: John E. McLoughlin, Hauppauge, NY (US); Neocles G. Athanasiades, E. Setauket, NY (US); Kiam Meng Toh, St. James, NY (US)

(72) Inventors: John E. McLoughlin, Hauppauge, NY (US); Neocles G. Athanasiades, E. Setauket, NY (US); Kiam Meng Toh, St. James, NY (US)

(73) Assignee: JNT Link, LLC, Nesconset, NY (US)

(21) Appl. No.: 13/281,187

(22) Filed: Oct. 25, 2011

(51) Int. Cl. A62C 31/28; A62C 37/36

(52) U.S. Cl. 169/46; 169/19; 137/355.18

(57) ABSTRACT

A system resides on a fire truck carrying at least one fire hose in a hose bay. The system comprises a target device coupled to the at least one fire hose, a proximity sensor coupled to the hose bay and operable to detect the presence and absence of the target device, and a controller coupled to the proximity sensor and control valve and operable to enable opening of the control valve in response to the proximity sensor detecting the absence of the target device indicative of a substantially complete removal of the at least one fire hose from the hose bay of the fire truck, and operable to disable opening of the control valve in response to the proximity sensor detecting the presence of the target device indicative of the at least one fire hose remaining in the hose bay of the fire truck.

### FIELD

The present disclosure relates to a system and method of automatic hose bay jam prevention generally for firefighting applications.

### BACKGROUND

Firefighting is a highly dangerous occupation that subjects firefighters to many hazards. An important asset to the firefighters is maintaining a steady and abundant water supply to suppress fire and/or filling a truck-mounted water tank. Both of these tasks are typically accomplished by using a pump on-board the fire truck that is driven by the truck engine. The water from the pump is typically conducted to the site of the fire using a lengthy fire hose. The fire hoses are typically laid flat many layers deep in a hose bay on a fire truck. A dangerous situation may occur when delay is introduced in getting the hoses organized and laid out for firefighting. Problem occurs when the hose is prematurely charged before the hose is completely removed from the hose bay. The hose becomes filled with water and jammed in the hose bay. This mistake introduces much unexpected delay and poses additional unnecessary risk to the firefighters at the scene.

### SUMMARY

A system and method of automatic hose bay jam prevention generally for firefighting applications is envisioned and described herein.

A system resides on a fire truck carrying at least one fire hose in a hose bay, a hose coupling connecting the at least one fire hose to an outlet of a pump, and a control valve operable to open or shut water flow from the outlet of the pump to the at least one fire hose. The system comprises a target device coupled to the at least one fire hose, a proximity sensor coupled to the hose bay and operable to detect the presence and absence of the target device, and a controller coupled to the proximity sensor and control valve and operable to enable opening of the control valve in response to the proximity sensor detecting the absence of the target device indicative of a substantially complete removal of the at least one fire hose from the hose bay of the fire truck, and operable to disable opening of the control valve in response to the proximity sensor detecting the presence of the target device indicative of the at least one fire hose remaining in the hose bay of the fire truck.

A method of preventing jamming of at least one fire hose laid in a hose bay of a fire truck, the fire truck having a pump operable to pump water to charge the fire hose, a hose coupling connecting the at least one fire hose to an outlet of the pump, and a control valve operable to open or shut water flow from the outlet of the pump to the at least one fire hose, the comprises receiving input to open the control valve, receiving sensed data from a proximity sensor coupled to the hose bay and a target device coupled to the at least one fire hose, the proximity sensor operable to detect the presence and absence of the target device, and enabling the opening of the control valve in response to the proximity sensor detecting the absence of the target device indicative of a substantially complete removal of the at least one fire hose from the hose bay of the fire truck.

A memory having encoded therein computer software code executable by a computer to implement a method of preventing jamming of at least one fire hose laid in a hose bay of a fire truck, a hose coupling connecting the at least one fire hose to an outlet of a pump, and a control valve operable to open or shut water flow from the outlet of the pump to the at least one fire hose, the computer-implemented method comprises receiving input to open the control valve, receiving sensed data from a proximity sensor coupled to the hose bay and a target device coupled to the at least one fire hose, the proximity sensor operable to detect the presence and absence of the target device, and enabling the opening of the control valve in response to the proximity sensor detecting the absence of the target device indicative of a substantially complete removal of the at least one fire hose from the hose bay of the fire truck.

### BRIEF DESCRIPTION OF THE DRAWINGS

FIGS. 1A and 1B are simplified block diagram of an exemplary embodiment of a system of automatic hose bay jam prevention generally for firefighting applications; and

FIG. 2 is a simplified flowchart of an exemplary method of automatic hose bay jam prevention generally for firefighting applications.

### DETAILED DESCRIPTION

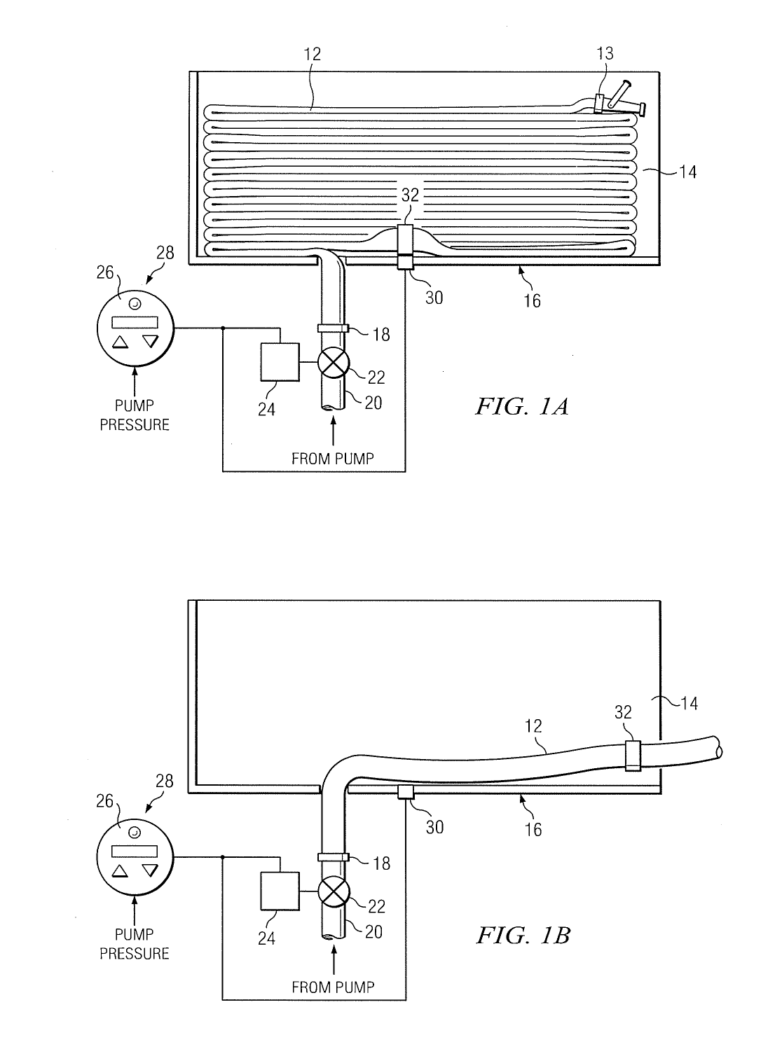

FIGS. 1A and 1B are simplified block diagrams of an exemplary embodiment of a system 10 of automatic hose bay jam prevention generally for firefighting applications. System 10 is shown in operation on a fire truck (not shown) that carries one or more fire hoses 12 within a hose bay 14. The hose bay 14 is generally a contained space on a fire truck where the fire hoses are stored and includes at least one wall 16. The fire hose 12 is typically laid into the bed of the hose bay in an organized and orderly manner so that it may be deployed quickly when time is of the essence. The fire hose 12 may be racked in the hose bay using one of several load configurations, including flat load, accordion load, horseshoe load, and roundabout load with the end of the hose coupled to the nozzle 13 laid on top of the folded hose. Often times, the hose 12 stored in the hose bay 14 is already pre-connected at a second end to the outlet of a pump (not shown) driven by the engine (not shown) of the fire truck via a coupling 18. A pipe or a conduit 20 connects the coupling 18 to the pump. In addition, a control valve 22 is disposed in the pipe 20 that is operable to open or close off the flow of water from the pump to the hose 12. The control valve 22 may be coupled to a motor, actuator, or solenoid 24, which is in turn coupled to a controller 26. The control valve 22 may be of any suitable type, such as, for example, a manually-operated valve or an electrically controlled hydraulic or pneumatic valve. The controller 26 may include a microcontroller or CPU (central processing unit) that is operable to execute computer software code stored in memory. The controller 26 further receives as one of its inputs the discharge pressure of the pump. The pump discharge pressure may be measured or sensed by a pressure transducer (not shown) or another suitable device and communicated to the controller 26 via wired or wireless transmission means. The controller 26 is operable to control the valve 22 based at least partly on the sensed pump discharge pressure data.

For example in a preferred embodiment, the controller 26 may compare the pump discharge pressure to a low set point and a high set point. If the pump pressure is above the high set point or below the low set point, the controller 26 is operable to keep the control valve 22 closed.

The controller 26 also includes a user interface 28 that is operable to provide status information and visual/audio alerts, as well as receive user input. The user interface 28 may include one or more lights, light-emitting-diodes, or other visual alerts, a liquid crystal display panel or other displays using technology now known or later developed, and one or more buttons or switches. The user interface 28 further includes one or more buttons, switches, keys, and other means of user input. The user may use the buttons to set the high and low pressure set points, for example.

Coupled to the wall 16 of the hose bay 14 is a proximity sensor 30 that is operable to sense whether a target device 32 is located proximately thereto. The target device 32 is coupled to the hose 12 near the coupling 18. The proximity sensor 30 and the target device 32 may operate using magnetic, electromagnetic, capacitive, electrostatic, inductive, and other now known or later developed principles. The target device 32 is coupled to a location on the hose 12 such that when substantially the entire length of the hose 12 is removed from the hose bay 14 and deployed for action, the target device 32 is outside the nominal range of the proximity sensor 30. FIG. 1B shows when the hose is substantially completely removed from the hose bay and deployed for action.

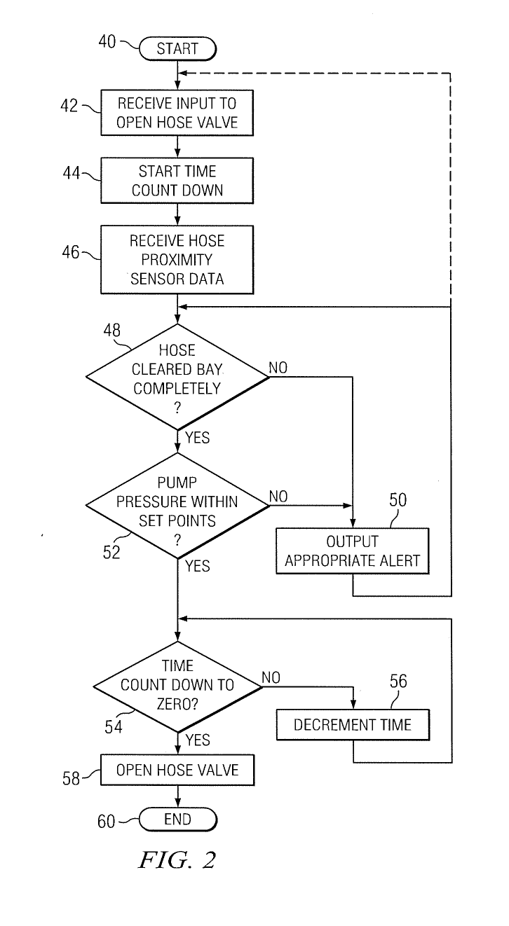

Although FIGS. 1A and 1B show the electrical connections between the controller 26 and the sensors and controls as wired connections, wireless transmission may be used instead or a combination thereof to send and receive sensed data and control information. It should be understood that although memory devices, interface circuits, analog-to-digital circuits, digital-to-analog circuits, and other devices known in the art are not explicitly shown in FIGS. 1A and 1B or described herein, such circuits and devices are included in the system 10 where required or appropriate to carry out the method shown in FIG. 2 and described below.

FIG. 2 is a simplified flowchart of an exemplary method 40 of automatic hose bay jam prevention generally for firefighting applications. The method 40 may be implemented in computer software code specifying logic and operations which are carried out in series of steps. In block 42, the operator may initiate the hose charging operation by providing an input to the user interface 28 of the controller 26 to open the control valve 22. In block 44, a count down is started. The count down introduces a programmable or fixed time delay between the user input to open the control valve to the actual opening of the control valve to charge the hose. In block 46, the controller 26 receives sensor data from the proximity sensor 30 indicative of the presence or absence of the target device 32. In block 48, a determination is made as to whether the hose 12 has entirely cleared the hose bay 14. If the proximity sensor 30 indicates that it detects the presence of the target sensor 32, then the process proceeds to block 50 to generate an appropriate visual or audio alert. The process may then proceed to block 42 or block 48 to override the charge hose input from the operator until the hose 12 has been completely removed from the hose bay 14. If the proximity sensor 30 detects the absence of the target device 32 in block 48, then the sensed pump discharge pressure is compared to the high and low set points in block 52. If the pump pressure is not within the low and high set points, then appropriate visual or audio information is generated and output to alert the operator in block 50. On the other hand, if the pump pressure is under the high set point and above the low set point (e.g., within proper operating parameters), then the count down is checked to see if the appropriate time delay has been reached in block 54. If the count down has not reached zero, then the time is decremented in block 56. If the count down has reached zero, then the controller 26 instructs the actuator 24 to open the control valve 22 to enable water from the pump to fill the hose in block 58. The process ends in block 60.

Although not explicitly described above, it is contemplated that a manual override capability may be provided to permit an operator to exert control notwithstanding the operations of the control system.

Accordingly, the disclosed method automatically checks whether the fire hose has been completely removed from the hose bay before allowing the hose control valve to be opened. In other words, the system automatically determines whether the fire hose is in a “ready” state prior to charging the hose with water. In this manner, human error is avoided and undue delays associated with hoses jammed in the hose bay because of premature charging is prevented.

It should be noted that the word “water” is used herein to generally convey the concept of a fluid used for firefighting purposes, and “water” may include water, foam, chemicals, and other types of fire-suppression fluids.

Further notice should be given regarding the actual implementation of the system in that certain changes and modifications to the described system, though not described explicitly or in detail, are contemplated herein. For example, the controller may be implemented using one or more CPU, microprocessor, or micro-controller circuits. Further, it is understood that a CPU is typically in operation with its attendant circuitry and software, such as memory, interfaces, drivers, etc. as known in the art.

The features of the present invention which are believed to be novel are set forth below with particularity in the appended claims. However, modifications, variations, and changes to the exemplary embodiments described above will be apparent to those skilled in the art, and the system and method of automatic hose bay jam prevention for firefighting applications described herein thus encompasses such modifications, variations, and changes and are not limited to the specific embodiments described herein.

What is claimed is:

1. A system residing on a fire truck carrying at least one fire hose in a hose bay, a hose coupling connecting the at least one fire hose to an outlet of a pump, and a control valve operable to open or shut water flow from the outlet of the pump to the at least one fire hose, comprising:
a target device coupled to the at least one fire hose;
a proximity sensor coupled to the hose bay and operable to detect the presence and absence of the target device; and
a controller coupled to the proximity sensor and control valve and operable to enable opening of the control valve in response to the proximity sensor detecting the absence of the target device indicative of a substantially complete removal of the at least one fire hose from the hose bay of the fire truck, and operable to disable opening of the control valve in response to the proximity sensor detecting the presence of the target device indicative of the at least one fire hose remaining in the hose bay of the fire truck.

2. The system of claim 1 wherein the proximity sensor and the target device comprise a material selected from a group consisting of magnetic, electromagnetic, capacitive, electrostatic, and inductive materials.

3. The system of claim 1 wherein the target device is coupled to the at least one fire hose proximate to the hose coupling.

4. A method of preventing jamming of at least one fire hose laid in a hose bay of a fire truck, the fire truck having a pump operable to pump water to charge the fire hose, a hose coupling connecting the at least one fire hose to an outlet of the pump, and a control valve operable to open or shut water flow from the outlet of the pump to the at least one fire hose, comprising:
receiving input to open the control valve;
receiving sensed data from a proximity sensor coupled to the hose bay and a target device coupled to the at least one fire hose, the proximity sensor operable to detect the presence and absence of the target device; and
enabling the opening of the control valve in response to the proximity sensor detecting the absence of the target device indicative of a substantially complete removal of the at least one fire hose from the hose bay of the fire truck.

5. The method of claim 4, further comprising disabling the opening of the control valve in response to the proximity sensor detecting the presence of the target device indicative of the at least one fire hose remaining in the hose bay of the fire truck, until the proximity sensor detects the absence of the target device.

6. A memory having encoded therein computer software code executable by a computer to implement a method of preventing jamming of at least one fire hose laid in a hose bay of a fire truck, a hose coupling connecting the at least one fire hose to an outlet of a pump, and a control valve operable to open or shut water flow from the outlet of the pump to the at least one fire hose, the computer-implemented method comprising:
receiving input to open the control valve;
receiving sensed data from a proximity sensor coupled to the hose bay and a target device coupled to the at least one fire hose, the proximity sensor operable to detect the presence and absence of the target device; and
enabling the opening of the control valve in response to the proximity sensor detecting the absence of the target device indicative of a substantially complete removal of the at least one fire hose from the hose bay of the fire truck.

7. The memory of claim 6, wherein the computer-implemented method further comprises disabling the opening of the control valve in response to the proximity sensor detecting the presence of the target device indicative of the at least one fire hose remaining in the hose bay of the fire truck, until the proximity sensor detects the absence of the target device.
